(19) United States
(12) Patent Application Publication
(10) Pub. No.: US 2026/0358961 A1
(43) Pub. Date: Nov. 12, 2026

(54) ACCELERATED MEMORY INITIALIZATION

(71) Applicant: Advanced Micro Devices, Inc., Santa Clara, CA (US)

(72) Inventors: Ravindra Pannapur, Bangalore (IN); Kedarnath Balakrishnan, Bangalore (IN)

(73) Assignee: Advanced Micro Devices, Inc., Santa Clara, CA (US)

(21) Appl. No.: 19/205,150

(22) Filed: May 12, 2025

(51) Int. Cl. G06F 3/06

(52) U.S. Cl. CPC G06F 3/0613; G06F 3/0659; G06F 3/0673

(57) ABSTRACT

A data processor includes a power controller configured to activate a memory initialization enable signal, and a memory channel controller responsive to the memory initialization enable signal to generate a plurality of memory initialization requests in an order that rotates through a plurality of different bank groups of a memory. The memory channel controller issues consecutive memory initialization commands in response to timing eligible memory initialization requests.

### BACKGROUND

Dynamic random-access memory (DRAM) chips are commonly used as main memory in modern data processing systems. DRAMs are based on tiny capacitors that store charge to represent a binary logic state. Upon startup, a computer operating system checks the DDR memory implemented in the data processing system for memory errors so that the operating system can avoid using those portions of memory. Most DRAM chips sold today are compatible with various double data rate (DDR) DRAM standards promulgated by the Joint Electron Devices Engineering Council (JEDEC). DDR DRAMs, including the latest DDR, version five (DDR5) DRAMs, are often sold in modules in which extra memory is added for error correcting code (ECC) bits. In order to avoid generating a data error for a read access to a memory location before a write access has occurred, the data processing system needs to initialize the DDR DRAM so that the ECC is set to a known state. This operation is known as a memory initialization operation. A memory clear operation is a type of memory initialization operation that clears the memory to the 0x00 state by writing the value of 0x00 to all the addresses of the memories in the memory system. Other memory initialization operations can write other data values to the memory. However, DDR DRAMs impose minimum timing constraints related to issuing consecutive memory write cycles to memory locations in the same memory bank group. These required minimum timings are especially long in DDR5 DRAMs such that a memory initialization operation such as a memory clear operation takes a significant amount of time, harming overall user experience at startup.

### BRIEF DESCRIPTION OF THE DRAWINGS

FIG. 1 illustrates in block diagram form a data processing system according to some implementations;

FIG. 2 illustrates in block diagram form a memory controller according to some implementations;

FIG. 3 illustrates in block diagram form an exemplary address rotator circuit that can be used as the address rotator in the memory controller of FIG. 2; and

FIG. 4 illustrates a flow chart for a process for an accelerated memory initialization operation according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

DDR5 DRAMs are organized into multiple bank groups, each of which contains multiple memory banks. For example, a typical DDR5 DRAM can have eight bank groups, each having four banks, for a total of 32 banks. Each bank in each bank group includes a contiguous portion in the memory address space. A problem arises when a memory controller performs a memory clear operation at startup to set the memory system to a known state and to initialize the error correcting code (ECC) so that it does not indicate an error if the memory location is read before data is written. In order to sequence through all addresses in the address space, the basic input/output system (BIOS) or operating system performing the memory clear operation would provide individual memory clear instructions for all memory addresses in the memory space. Performing memory clear operations to consecutive memory addresses would proceed slowly due to a timing parameter that specifies a minimum write-to-write delay for consecutive write commands. The timing specification is large and has grown larger in DDR5 DRAMs. For example, current DDR5 DRAMs specify a minimum of 24 memory clock cycles that must exist between two writes to a bank in the same bank group.

However, DDR5 DRAMs specify a minimum of only 8 cycles between consecutive memory commands to different bank groups. According to the disclosed implementations, a memory controller, a data processor using such a memory controller, and a method avoid the relatively large same-bank write-to-write penalty by automatically rotating memory clear requests through different bank groups, such that the frequency of issuing such memory commands is limited only by the shorter different-bank-group write-to-write timing specification.

In some implementations, the disclosed memory controller includes an address rotator circuit that changes otherwise consecutive memory writes to the same bank and bank group in the memory space by rotating them through the different bank groups of the memory. The order of addresses does not change the overall memory clear operation, but just scrambles the order of the accesses to allow them to be processed faster.

In some implementations, the address rotator circuit supports both a normal or “default” mode in which certain bits of the address select the bank group, and a “bank swap” mode in which other bits of the address are used to select the bank group, making it compatible with existing modes of accessing the memory during normal operation.

In the some implementations, the memory controller leverages the timing eligibility check circuitry already present in the memory controller's arbiter to automatically select commands from a pool of commands stored in a command queue that perform a write operation to a memory location in a different bank group, because these commands will become timing eligible sooner than other accesses to the same bank group. In this case, the memory controller only adds a small bank group address rotator circuit that causes received, sequential memory clear operations to be automatically rotated through the bank groups without software intervention, but otherwise leverages existing timing eligibility mechanisms.

A data processor includes a power controller configured to activate a memory initialization enable signal, and a memory channel controller responsive to the memory initialization enable signal to generate a plurality of memory initialization requests in an order that rotates through a plurality of different bank groups of a memory. The memory channel controller issues consecutive memory initialization commands in response to timing eligible memory initialization requests.

A data processing system includes a memory and a data processor. The data processor includes a power controller, a memory channel controller, and a memory accessing agent. The power controller is configured to activate a memory initialization enable signal. The memory channel controller is responsive to the memory initialization enable signal to generate a plurality of memory initialization requests in an order that rotates through a plurality of different bank groups of a memory. The memory channel controller issues consecutive memory initialization commands in response to timing eligible memory initialization requests. The memory accessing agent is configured to instruct the power controller to start a memory initialization operation.

A method includes activating a memory initialization enable signal by a data processor. A plurality of memory initialization requests is generated by a memory controller in an order that rotates through a plurality of different bank groups of a memory in response to the memory initialization enable signal. Consecutive memory initialization commands are issued in response to timing eligible memory initialization requests.

A data processing system, memory controller, and method as described herein allows a faster memory initialization operation, e.g., a memory clear operation, to take place at startup, providing a better user experience. The disclosed implementations only add a relatively small address rotator circuit. It allows a reduction in boot-up time, the number of activate, precharge, and refresh commands required during boot-up, and overall boot-up power.

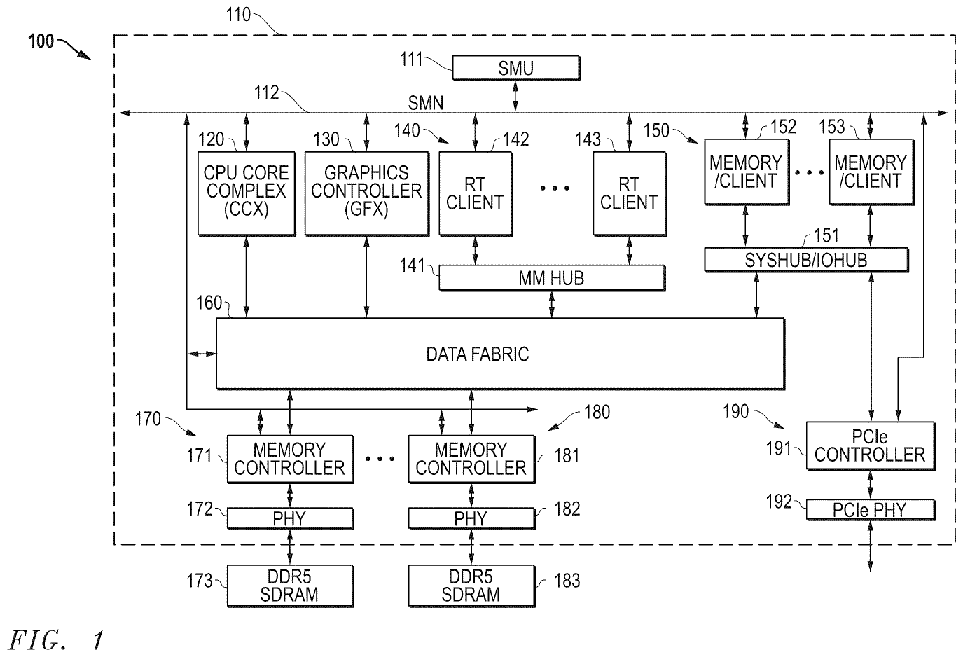

FIG. 1 illustrates in block diagram form a data processing system 100 according to some implementations. Data processing system 100 includes a data processor 110 in the form of an APU and memory in the form of Double Data Rate, version 5, synchronous dynamic random-access memory (DDR5 SDRAMs) including a DDR5 memory 173 and a DDR5 memory 183. Many other components of an actual data processing system are typically present but are not relevant to understanding the present disclosure and are not shown in FIG. 1 for ease of illustration.

Data processor 110 includes generally a system management unit 111 labelled “SMU”, a system management network (SMN) 112, a central processing unit (CPU) core complex 120 labeled “CCX”, a graphics controller 130 labeled “GFX”, a real-time client subsystem 140, a memory/client subsystem 150, a data fabric 160, memory channels 170 and 180, and a Peripheral Component Interface Express (PCIe) subsystem 190. As will be appreciated by a person of ordinary skill, data processor 110 may not have all of these elements present in every implementation and, further, may have additional elements included therein.

SMU 111 is bidirectionally connected to the major components in data processor 110 over SMN 112. SMN 112 forms a control fabric for data processor 110. SMU 111 is a local controller that controls the operation of the resources on data processor 110 and synchronizes communication among them. SMU 111 manages power-up sequencing of the various processors on data processor 110 and controls multiple off-chip devices via reset, enable and other signals. SMU 111 includes one or more clock sources (not shown), such as a phase locked loop (PLL), to provide clock signals for each of the components of data processor 110. SMU 111 also manages power for the various processors and other functional blocks, and may receive measured power consumption values from CPU cores in CPU core complex 120 and graphics controller 130 to determine appropriate P-states.

CPU core complex 120 includes a set of CPU cores, each of which is bidirectionally connected to SMU 111 over SMN 112. Each CPU core may be a unitary core only sharing a last-level cache with the other CPU cores, or may be combined with some but not all of the other cores in clusters.

Graphics controller 130 is bidirectionally connected to SMU 111 over SMN 112. Graphics controller 130 is a high-performance graphics processing unit capable of performing graphics operations such as vertex processing, fragment processing, shading, texture blending, and the like in a highly integrated and parallel fashion. In order to perform its operations, graphics controller 130 requires periodic access to external memory. In the implementation shown in FIG. 1, graphics controller 130 shares a common memory subsystem with CPU cores in CPU core complex 120, an architecture known as a unified memory architecture. Because data processor 110 includes both a CPU and a GPU, it is also referred to as an accelerated processing unit (APU).

Real-time client subsystem 140 includes a set of real-time clients such as representative real time clients 142 and 143, and a memory management hub 141 labeled “MM HUB”. Each real-time client is bidirectionally connected to SMU 111 over SMN 112, and to memory management hub 141. Real-time clients in real-time client subsystem 140 could be any type of peripheral controller that requires periodic movement of data, such as an image signal processor (ISP), an audio coder-decoder (codec), a display controller that renders and rasterizes objects generated by graphics controller 130 for display on a monitor, and the like.

Memory/client subsystem 150 includes a set of memory elements or peripheral controllers such as representative memory/client devices 152 and 153, and a system and input/output hub 151 labeled “SYSHUB/IOHUB”. Each memory/client device is bidirectionally connected to SMU 111 over SMN 112, and to system and input/output hub 151. Memory/client devices are circuits that either store data or require access to data on an aperiodic fashion, such as a non-volatile memory, a static random-access memory (SRAM), an external disk controller such as a Serial Advanced Technology Attachment (SATA) interface controller, a universal serial bus (USB) controller, a system management hub, and the like.

Data fabric 160 is an interconnect that controls the flow of traffic in data processor 110. Data fabric 160 is bidirectionally connected to SMU 111 over SMN 112, and is bidirectionally connected to CPU core complex 120, graphics controller 130, memory management hub 141, system and input/output hub 151. Data fabric 160 includes a crossbar switch for routing memory-mapped access requests and responses between any of the various devices of data processor 110. It includes a system memory map, defined by a basic input/output system (BIOS), for determining destinations of memory accesses based on the system configuration, as well as buffers for each virtual connection.

Memory channels 170 and 180 are circuits that control the transfer of data to and from DDR5 memory 173 and DDR5 memory 183. Memory channel 170 is formed by a memory controller 171 and a physical interface circuit 172 labeled “PHY” connected to DDR5 memory 173. Memory controller 171 is bidirectionally connected to SMU 111 over SMN 112 and has an upstream port bidirectionally connected to data fabric 160, and a downstream port, in which the upstream port receives memory access requests, and the downstream port provides memory commands. Physical interface circuit 172 has an upstream port bidirectionally connected to memory controller 171, and a downstream port bidirectionally connected to DDR5 memory 173. Similarly, memory channel 180 is formed by a memory controller 181 and a physical interface circuit 182 connected to DDR5 memory 183. Memory controller 181 is bidirectionally connected to SMU 111 over SMN 112 and has an upstream port bidirectionally connected to data fabric 160, and a downstream port. Physical interface circuit 182 has an upstream port bidirectionally connected to memory controller 181, and a downstream port bidirectionally connected to DDR5 memory 183.

Peripheral Component Interface Express (PCIe) subsystem 190 includes a PCIe controller 191 and a PCIe physical interface circuit 192. PCIe controller 191 is bidirectionally connected to SMU 111 over SMN 112 and has an upstream port bidirectionally connected to system and input/output hub 151, and a downstream port. PCIe physical interface circuit 192 has an upstream port bidirectionally connected to PCIe controller 191, and a downstream port bidirectionally connected to a PCIe fabric, not shown in FIG. 1. PCIe controller is capable of forming a PCIe root complex of a PCIe system for connection to a PCIe network including PCIe switches, routers, and devices.

In operation, data processor 110 integrates a complex assortment of computing and storage devices, including CPU core complex 120 and graphics controller 130, on a single chip. Most of the features of these controllers are well known and will not be discussed further. However, as will be described in greater detail below, a data processor includes a memory controller with a command queue for storing memory access requests and a refresh controller, connected to the command queue and operable to select an order of providing same bank refresh commands to a plurality of refresh groups of corresponding banks in the memory based on an aggregate request count of the memory access requests in the command queue. Specifically, during a round of same bank refreshes, the memory controller repeatedly picks refresh groups with the lowest aggregate request count among the refresh groups that have not yet been picked in the current round until all refresh groups have been picked. Thus, the memory controller ensures that all memory banks are refreshed with the refresh interval (tREFI), while intelligently selecting the order to improve bus utilization and reduce command latency.

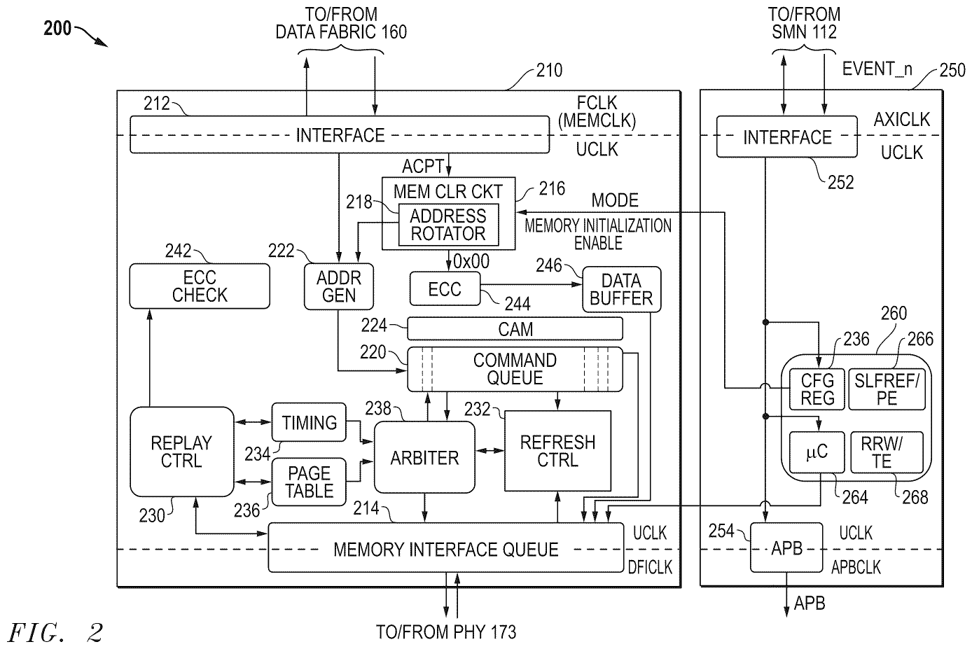

FIG. 2 illustrates in block diagram form a memory controller 200 according to some implementations. Memory controller 200 includes a memory channel controller 210 and a power controller 250. Memory channel controller 210 includes an interface 212, a memory interface queue 214, a command queue 220, an address generator 222, a content addressable memory 224 labelled “CAM”, a replay queue 230, a refresh controller 232, a timing eligibility circuit 234, a page table 236, an arbiter 238, an ECC check circuit 242, an ECC generation circuit 244, and a data buffer 246 labelled “DB”.

Interface 212 has a first bidirectional connection to data fabric 125 over an external bus, and has an output. Interface 212 translates memory access requests from a first clock domain known as the FCLK (or MEMCLK) domain to a second clock domain internal to memory controller 200 known as the UCLK domain. Similarly, memory interface queue 214 provides memory accesses from the UCLK domain to the DFICLK domain associated with the DFI interface.

Address generator 222 decodes addresses of memory access requests received from data fabric 125. The memory access requests include access addresses in the physical address space represented in as a normalized address. Address generator 222 converts the normalized addresses into a format that can be used to address the actual memory devices in the memory system, as well as to efficiently schedule related accesses. This format includes a region identifier that associates the memory access request with a particular rank, a row address, a column address, a bank address, and a bank group. On startup, the system BIOS queries the memory devices in the memory system to determine their size and configuration, and programs a set of configuration registers associated with address generator 222. Address generator 222 uses the configuration stored in the configuration registers to translate the normalized addresses into the appropriate format.

Command queue 220 is a queue of memory access requests received from the memory accessing agents in data processor 110, such as CPU core complex 120, graphics controller 130, etc., and waiting to be issued as corresponding memory commands to the memory system. Command queue 220 stores the address fields decoded by address generator 222 as well other address information that allows arbiter 238 to select memory accesses efficiently, including access type and quality of service (QoS) identifiers. Content addressable memory 224 includes information to enforce ordering rules, such as write after write (WAW) and read after write (RAW) ordering rules.

Replay queue 230 is a temporary queue for storing memory accesses picked by arbiter 238 that are awaiting responses, such as address and command parity responses, write cyclic redundancy check (CRC) responses for DDR4 DRAM write and read CRC responses for GDDR5 DRAM. If the memory system supports an error correcting code, such as an ECC dual inline memory module (DIMM), replay queue 230 accesses ECC check circuit 242 to determine whether the returned ECC is correct, whether the ECC indicates a correctable error and ECC check circuit 242 has corrected it, or whether the ECC indicates an uncorrectable error. Replay queue 230 allows the accesses to be replayed in the case of a parity or CRC error of one of these cycles.

Refresh controller 232 is a hardware circuit that includes various circuitry including timers, counters, state machines, registers, digital logic, and the like to implement same bank refresh commands, as well as various powerdown, refresh, and termination resistance (ZQ) calibration cycles that are generated separately from normal read and write memory access requests received from memory accessing agents. For example, if a memory rank is in precharge powerdown, it must be periodically awakened to run refresh cycles. In general, refresh controller 232 generates refresh commands periodically to prevent data errors caused by leaking of charge off storage capacitors of memory cells in DRAM chips. In addition, refresh controller 232 periodically calibrates ZQ to prevent mismatch in on-die termination resistance due to thermal changes in the system. Refresh controller 232 decides when to put DRAM devices in different power down modes.

Arbiter 238 is bidirectionally connected to command queue 220 and is the heart of memory channel controller 210. It improves efficiency by intelligent scheduling of memory commands from among the memory access requests in command queue 220 to improve the usage of the memory bus. Arbiter 238 uses timing eligibility circuit 234 to enforce proper timing relationships by determining whether certain memory access requests in command queue 220 are eligible for issuance as memory commands based on DRAM timing parameters. For example, each DRAM has a minimum specified time between activate commands to the same bank, known as “t_{RC}”. Timing eligibility circuit 234 maintains a set of counters that determine eligibility based on this and other timing parameters specified in the JEDEC specification, and is bidirectionally connected to replay queue 230. Page table 236 maintains state information about active pages in each bank and rank of the memory channel for arbiter 238, and is bidirectionally connected to replay queue 230.

In response to read memory access requests received from memory interface queue 214, ECC check circuit 242 extracts the metadata bits from the ECC code and determines whether there is an error in the ECC code, and if the error is a correctable error, to correct the data. ECC check circuit 242 is able to extract the metadata bits, detect and correct single symbol errors in the retuned data and detect but not correct multiple symbol errors with high accuracy.

In response to write memory access requests received from interface 212, ECC generation circuit 244 computes an ECC according to the write data. Data buffer 246 stores the write data and ECC for received memory access requests. It outputs the combined write data/ECC to memory interface queue 214 when arbiter 238 picks the corresponding write access for dispatch to the memory channel.

Power controller 250 includes an interface 252 to an advanced extensible interface, version one (AXI), an APB interface 254, and a power engine 260. Interface 252 has a first bidirectional connection to the SMN, which includes an input for receiving an event signal labeled “EVENT_n” shown separately in FIG. 2, and an output. APB interface 254 has an input connected to the output of interface 252, and an output for connection to a PHY over an APB. Power engine 260 has an input connected to the output of interface 252, and an output connected to an input of memory interface queue 214. Power engine 260 includes a set of configuration registers 262, a microcontroller (μC) 264, a self refresh controller 266 labelled “SLFREF/PE”, and a reliable read/write training engine 268 labelled “RRW/TE”. Configuration registers 262 are programmed over the AXI bus, and store configuration information to control the operation of various blocks in memory controller 200. Accordingly, configuration registers 262 have outputs connected to these blocks that are not shown in detail in FIG. 2. Self refresh controller 266 is an engine that allows the manual generation of refreshes in addition to the automatic generation of refreshes by refresh controller 232. Reliable read/write training engine 268 provides a continuous memory access stream to memory or I/O devices for such purposes as DDR interface read latency training and loopback testing.

Memory channel controller 210 includes circuitry that allows it to pick memory accesses for dispatch to the associated memory channel. In order to make the desired arbitration decisions, address generator 222 decodes the address information into predecoded information including rank, row address, column address, bank address, and bank group in the memory system, and command queue 220 stores the predecoded information. Configuration registers 262 store configuration information to determine how address generator 222 decodes the received address information. Arbiter 238 uses the decoded address information, timing eligibility information indicated by timing eligibility circuit 234, and active page information indicated by page table 236 to efficiently schedule memory accesses while observing other criteria such as QoS requirements. For example, arbiter 238 implements a preference for accesses to open pages to avoid the overhead of precharge and activation commands required to change memory pages, and hides overhead accesses to one bank by interleaving them with read and write accesses to another bank. In particular during normal operation, arbiter 238 may decide to keep pages open in different banks until they are required to be precharged prior to selecting a different page.

Memory channel controller 210 also includes a memory clear circuit 216. Memory channel controller 210 is responsive to a memory clear enable signal received from power controller 250 to generate memory clear requests in an order that rotates such that memory channel controller issues consecutive memory clear commands in response to a plurality of memory clear requests in an order that rotates through a plurality of different bank groups of a memory. The memory clear requests are write memory access requests with certain data, e.g., 0x00. In the illustrated implementation, memory clear circuit 216 generates the memory clear requests in response to a memory initialization enable signal received from power controller 250. Memory clear circuit 216 includes an address rotator circuit 218 that generates a plurality of memory clear requests, and memory channel controller 210 issues the memory clear commands by rotating the bank group that is accessed between consecutive commands. Memory channel controller 210 leverages existing memory timing eligibility mechanisms that arbiter 238 uses in conjunction with timing eligibility circuit 234 to select the memory commands that become timing eligible first. The eligibility criteria include a shorter delay between write commands to different bank groups. By generating a sequence of memory clear requests to command queue 220 that rotate through the different bank groups, memory channel controller 210 achieves fast memory clear operations with only a small amount of added circuitry.

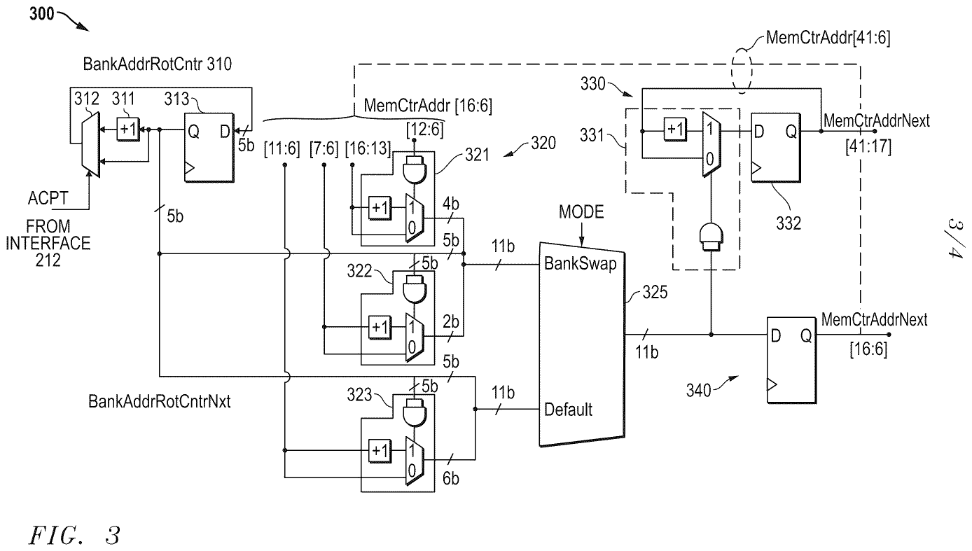

FIG. 3 illustrates in block diagram form an exemplary address rotator circuit 300 that can be used to implement address rotator circuit 218 in memory controller 200 of FIG. 2. Address rotator circuit 300 is one specific implementation of an address rotator circuit, and in other implementations, other address bits can be used for other DRAM densities, numbers of banks, etc. Address rotator circuit 300 generally includes a bank address rotation counter 310, a bank address generation circuit 320, a memory clear address output circuit 330, and a memory clear address output circuit 340.

Bank address rotation counter 310 includes an incrementor 311, a selector 312, and a latch 313. Incrementor 311 has an input for receiving a 5-bit bank address, and an output. Selector 312 has a first input connected to the output of incrementor 311, a second input for receiving the 5-bit bank address, a control input for receiving an accept signal labelled “ACPT” from interface 212 of FIG. 2, and an output. Memory clear address output latch 313 has a D input connected to the output of selector 312, a clock input for receiving a clock signal (e.g., the UCLK signal) not shown in FIG. 3, and a Q output for providing the 5-bit bank address.

Bank address generation circuit 320 includes three incrementors 321, 322, and 323. Incrementor 321 and a first input for receiving MemClrAddr[12:6], a second input for receiving MemClrAddr[16:13], and an output. Incrementor 322 has a first input for receiving BankAddrRotCntrNxt, a second input for receiving MemClrAddr[41:6], and an output. Together the outputs of incrementor 321, bank address rotation counter 310, and the output of incrementor 322 form an 11-bit signal used in Bank Swap mode. Incrementor 323 has a first input for receiving the 5-bit bank address from bank address rotation counter 310, a second input for receiving MemClrAddr[11:6], and an output.

Memory clear address output circuit 330 includes an incrementor 331 and a latch 332. Incrementor 331 selects either the input or an incremented version of the input when the least significant portion of the address, bits [16:6], are all “1” or the current input otherwise. Memory clear address output circuit 330 forms the most significant address bits, and only increments when the least significant 11 bits of the memory clear address is equal to all “1” , and otherwise increments through the address space of memory controller 200 until all populated addresses are cleared.

Memory clear address output circuit 340 has a D input for receiving the output of selector 325, a clock input for receiving the clock signal (not shown), and a Q output for providing the least significant bits of the memory clear address, namely bits [16:6].

In operation, bank address rotation counter 310 ensures that memory channel controller 210 issues consecutive memory clear commands in response to a plurality of memory clear requests in an order that rotates through all the different bank groups of memory 173. Bank address rotation counter 310 generates the next address once every “N” cycles, in which N is the number of cycles to complete a clear operation, generally the write-to-write command delay for different bank groups. When interface 212 signals a new memory clear operation, it outputs the ACPT control signal to select the “1” input corresponding to the output of incrementor 311. That causes the incremented bank address to be stored in latch 313 at the next edge of the clock signal.

Bank address generation circuit 320 forms the least significant portion of bank group fields in the lower 11 bits of the memory clear address, in which each memory clear address is the starting address of a 64-byte (64 B) region, e.g., a cache line, that can be addressed in a single burst cycle. Each of incrementors 321, 322, and 323 increments when certain address bits cross a respective boundary.

In the bank swap mode, incrementors 321 and 322 are used to form an 11-bit portion—bits [16:6]—of the memory clear address [41:6]. Incrementor 321 selects the 4 most-significant bits [16:13] of the 11-bit portion of the memory clear address. Incrementor 321 includes a 7-input AND gate that controls a selector to select either the four most-significant address bits [16:13] as the current value of address bits [16:13] when less significant address bits [12:6] are not all “1”, or address bits [16:13] incremented by one when less significant address bits [12:6] are all “1”. The five next less significant bits [12:8] of the 11-bit portion of the memory clear address are supplied by the output of bank address rotation counter 310. Incrementor 322 selects the two least significant bits [7:6] of the 11-bit portion of the memory clear address. Incrementor 322 includes a 5-input AND gate that controls a selector to select two most-significant address bits [7:6] as the current value of address bits [7:6] when less significant address bits [10:6] are not all “1”, or address bits [7:6] incremented by one when less significant address bits [10:6] are all “1”. In the Bank Swap mode, the memory clear address is expressed as:

MemClrAddr[41:6]={MemClrAddrNxt[41:7]∥BankAddrRotCntrNxt[4:0]∥MemClrAddrNxt[11:6]} [1]

In the default mode, incrementor 323 is used to form the 11-bit portion of the memory clear address [41:6]. Incrementor 322 includes a 5-input AND gate that selects the output of incrementor 326 when address bits [16:12] are not all “1” , and selects the current value of address bits [7:6] otherwise. Incrementor 323 includes a 5-input AND gate that controls a selector to select either the six least-significant address bits [11:6] as the current value of address the memory clear address, when less significant address bits [12:6] are not all “1” , or address bits [16:13] incremented by one when less significant address bits [12:6] are all “1”. Incrementor 323 includes a 6 b input from address bits [11:6], a second input from the output of bank address rotation counter 310, and output. Incrementor 323 increments its count when the incremented version of address bits [11:6] is selected. In the Default mode, the memory clear address is expressed as:

MemClrAddr[41:6]={MemClrAddrNxt[41:13]∥BankAddrRotCntrNxt[4:0]∥MemClrAddrNxt[7:6]} [2 ]

Memory clear address output circuit 330 includes an incrementor 331 and a latch 332. Incrementor 331 includes an 11-input AND gate that selects the output of latch 332 when memory clear address bits [16:6] are not all “1” , and selects the output of latch 332 incremented by one when memory clear address bits [16:6] are not all “1”. Latch 332 captures the D input on the edge of a clock signal, such as the UCLK signal, not shown in FIG. 3.

Memory clear address output circuit 340 captures the 11-bit output of selector 325 at the D input on the edge of a clock signal, such as the UCLK signal, and the Q output provides the least significant bits of the memory clear address, namely bits [16:6]. Thus, the memory clear address [41:6] forms the starting address of a burst write cycle that is used for a memory clear operation.

Address rotator circuit 300 is one implementation of address rotator 215 of FIG. 2. It should be apparent that other address rotators are possible, as well as address rotators that support multiple address sizes, numbers of bank groups, numbers of banks, etc. Moreover, address rotator circuit 300 can be used with other memory initialization operations besides memory clear operations, in which these other memory initialization operations write other values than 0x00 to the memory system.

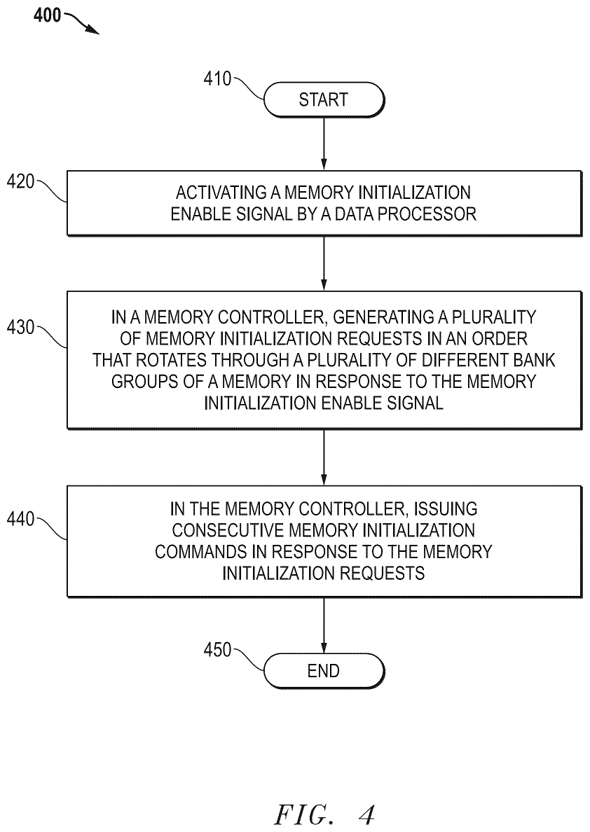

FIG. 4 illustrates a flow chart 400 of a method for an accelerated memory initialization operation according to some implementations. The method starts at an action box 410. An action box 420 includes activating a memory initialization enable signal by a data processor. An action box 430 includes, in a memory controller, generating a plurality of memory initialization requests in an order that rotates through a plurality of different bank groups of a memory in response to the memory initialization enable signal. An action box 440 includes, in the memory controller, issuing consecutive memory initialization commands in response to the plurality of memory initialization requests. The method ends in an action box 450.

Thus, a memory controller, data processing system, and memory have been described that perform a memory initialization operation such as a memory clear on a bank-group oriented memory device faster than sequential addressing, promoting fast startup and better user experience. The memory controller implements a relatively small bank address rotator circuit that is a hardware circuit that generates modified addresses in which sequentially issued memory access requests access different bank groups. The bank address rotator circuit leverages existing memory controller circuitry, such as an arbiter with timing eligibility timer and a command queue for storing a pool of commands from which the arbiter may select commands that become timing eligible sooner because the different bank group write-to-write minimum delay is significantly shorter than the same bank group write-to-write minimum delay.

While particular implementations have been described, various modifications of these implementations will be apparent to those skilled in the art. For example, instead of rotating addresses through other bank groups that clear the contents of the memory locations to a value of 0x00, the memory initialization operation can initialize the memory locations to another fixed value such as 0xFF, 0x55, 0xAA, or any other desirable value. In some implementations, different bank group addressing options are supported, such as the Default and Bank Swap modes discussed above. Also, the memory controller is responsive to sequential addresses that are input to the address rotator circuit that are generated by hardware, firmware, or software. While the address rotator circuit was described in terms of a specific circuit implementation, it should be apparent that other equivalent circuit implementations can be used. Moreover, while the disclosed implementations used DDR5 DRAMs, other implementations may use other memory types and versions.

Accordingly, it is intended by the appended claims to cover all modifications of the disclosed implementations that fall within the scope of the disclosed implementations.

What is claimed is:

1. A data processor, comprising:
a power controller configured to activate a memory initialization enable signal; and
a memory channel controller, responsive to the memory initialization enable signal, to generate a plurality of memory initialization requests in an order that rotates through a plurality of different bank groups of a memory, wherein the memory channel controller issues consecutive memory initialization commands in response to timing eligible memory initialization requests.

2. The data processor of claim 1, further comprising:
a memory accessing agent configured to instruct the power controller to start a memory initialization operation.

3. The data processor of claim 2, further comprising:
the memory accessing agent is configured to instruct the power controller to start the memory initialization operation in response to executing instructions of a basic input/output system (BIOS).

4. The data processor of claim 1, wherein the memory channel controller comprises:
an interface having an input for receiving memory access requests, and an output;
a memory clear circuit responsive to the memory initialization enable signal to generate memory clear requests for all memory addresses in the memory;
a command queue for storing the memory clear requests; and
an arbiter configured to select the memory clear requests from the command queue and send corresponding memory clear commands to the memory.

5. The data processor of claim 4, wherein the memory clear circuit generates the memory clear requests for all locations in the memory such that consecutive memory clear requests have addresses corresponding to different bank groups.

6. The data processor of claim 5, wherein:
the memory clear circuit further rotates through the plurality of different bank groups of the memory in rotation cycles that cause memory clear requests to the same bank group to be separated by a number of other memory clear requests corresponding to a time greater than or equal to a minimum same bank group write-to-write specification of the memory.

7. The data processor of claim 1, wherein:
the power controller is further configured to provide a mode signal; and
the memory channel controller is responsive to the mode signal to select which bits of an address correspond to the different bank groups of a memory.

8. The data processor of claim 4, wherein:
the memory channel controller further comprises a timing eligibility circuit that indicates whether commands in the command queue are eligible to be issued based on a minimum same bank group write-to-write specification of the memory; and
responsive to the timing eligibility circuit, the arbiter is to select memory clear requests from the command queue for dispatch to the memory that are timing eligible and to reject memory clear requests that are not timing eligible.

9. A data processing system, comprising:
a memory; and
a data processor, comprising:
a power controller configured to activate a memory initialization enable signal;
a memory channel controller responsive to the memory initialization enable signal to generate a plurality of memory initialization requests in an order that rotates through a plurality of different bank groups of a memory, wherein the memory channel controller issues consecutive memory initialization commands in response to timing eligible memory initialization requests; and
a memory accessing agent configured to instruct the power controller to start a memory initialization operation.

10. The data processing system of claim 9, wherein the memory channel controller comprises:
an interface having an input for receiving memory access requests, and an output;
a memory clear circuit responsive to the memory initialization enable signal to generate memory clear requests for all memory addresses in the memory;
a command queue for storing the memory clear requests; and
an arbiter configured to select the memory clear requests from the command queue and send corresponding memory clear commands to the memory.

11. The data processing system of claim 10, wherein the memory clear circuit generates the memory clear requests for all locations in the memory such that consecutive memory clear requests have addresses corresponding to different bank groups.

12. The data processing system of claim 11, wherein:
the memory clear circuit further rotates through the plurality of different bank groups of the memory in rotation cycles that cause memory clear requests to the same bank group to be separated by a number of other memory clear requests corresponding to a time greater than or equal to a minimum same bank group write-to-write specification of the memory.

13. The data processing system of claim 10, wherein:
the memory channel controller further comprises a timing eligibility circuit that indicates whether commands in the command queue are eligible to be issued based on a minimum same bank group write-to-write specification of the memory; and
responsive to the timing eligibility circuit, the arbiter is to select memory clear requests from the command queue for dispatch to the memory that are timing eligible and to reject memory clear requests that are not timing eligible.

14. The data processing system of claim 9, wherein:
the power controller is further configured to provide a mode signal; and
the memory channel controller is responsive to the mode signal to select which bits of an address correspond to the different bank groups of a memory.

15. A method, comprising:
activating a memory initialization enable signal by a data processor; and
in a memory controller:
generating a plurality of memory initialization requests in an order that rotates through a plurality of different bank groups of a memory in response to the memory initialization enable signal; and
issuing consecutive memory initialization commands in response to timing eligible memory initialization requests.

16. The method of claim 15, further comprising:
generating memory clear requests for all memory addresses in the memory in response to the memory initialization enable signal;
storing the memory clear requests in a command queue; and
selecting the memory clear requests from the command queue and sending corresponding memory clear commands to the memory in response to the selecting.

17. The method of claim 16, further comprising:
generating the memory clear requests for all memory addresses in the memory such that consecutively generated memory clear requests have addresses corresponding to different bank groups.

18. The method of claim 17, wherein:
generating the memory clear requests comprises generating the memory clear requests using an address rotator circuit responsive to a base address and a limit address.

19. The method of claim 17, wherein the generating comprises:
rotating through the plurality of different bank groups of the memory in rotation cycles that cause memory clear requests to the same bank group to be separated by a number of other memory clear requests corresponding to a time greater than or equal to a minimum same bank group write-to-write specification of the memory.

20. The method of claim 15, further comprising:
storing memory clear requests in a command queue;
indicating whether commands in the command queue are eligible to be issued based on a minimum same bank group write-to-write specification of the memory; and
selecting memory clear requests from the command queue for dispatch as corresponding memory clear commands to the memory in response to the indicating.
